(19) United States
(12) Patent Application Publication
(10) Pub. No.: US 2014/0219640 A1
(43) Pub. Date: Aug. 7, 2014

(54) METHOD AND APPARATUS FOR STORING AND PLAYING 3D VIDEO SOURCE

(71) Applicant: TENCENT TECHNOLOGY (SHENZHEN) COMPANY LIMITED, Shenzhen (CN)

(72) Inventor: Jing LAI, Shenzhen (CN)

(73) Assignee: TENCENT TECHNOLOGY (SHENZHEN) COMPANY LIMITED, Shenzhen (CN)

(21) Appl. No.: 14/249,770

(22) Filed: Apr. 10, 2014

Related U.S. Application Data
(63) Continuation of application No. PCT/CN2013/073968, filed on Apr. 9, 2013.

(30) Foreign Application Priority Data
May 19, 2012 (CN) 201210156555.6

(51) Int. Cl. H04N 13/00

(52) U.S. Cl. CPC H04N 13/0055; H04N 13/0007
USPC 386/341; 386/353

(57) ABSTRACT

Embodiments of the present disclosure disclose a method and apparatus for storing and playing a 3D video source. The method includes: alternately storing video frames of a left-eye video source and a right-eye video source in media data storage units of a multimedia storage file in a chronological order; and storing the media information of the left-eye video source and the right-eye video source in different media information storage units of the multimedia storage file. With the above method, when a player client plays a 3D video online, the client player is able to synthesize 3D video with the left-eye video source and right-eye video source obtained from the downloaded media stream data while simultaneously downloading continuous media stream data of a multimedia storage file. The client player can synthesize 3D video without all the download being complete, to thereby play while downloading.

### CROSS-REFERENCE TO RELATED APPLICATIONS

The present application is a continuation application of International Application PCT/CN2013/073968, filed Apr. 9, 2013, and claims foreign priority to Chinese application 201210156555.6 filed May 19, 2012, and which are incorporated herein by reference in their entireties.

### TECHNICAL FIELD

The present disclosure generally relates to multimedia technology, and more particularly to a method and apparatus for storing and playing a 3D video source, and a computer storage medium which includes instructions configured to execute the method for storing and playing the 3D video source.

### BACKGROUND

The three-dimensional (3D) visual effect of a three-dimensional 3D image is due to “visual translocation”. A person's eyes are about 6cm apart. As a result, when looking at an object, the eyes are viewing from two viewpoints respectively. The left eye will see the object's left side and the right eye will see the object's centre or right side. As the objects, seen by two eyes, are imaged on the retina, the left and right images will overlap and form the final stereoscopic feeling. Effect of obtaining the stereoscopic feeling is the so-called “visual translocation”.

According to the above principle, when taking videos, parallax between the left and right eyes is imitated by two cameras, and each camera takes a video respectively. Then the two films are screened on a screen simultaneously, and added with necessary technical means in order to make it so that the audience's left eye can only see the left eye image and right eye can only see the right eye image. Finally, after the two images are superimposed in the brain, the audience can see the three-dimensional image.

To form a 3D image, two films of a scene, which are the left-eye video source and the right-eye video source, need to be taken accordingly. Conventional methods for storing a 3D video source generally store left-eye video source and right-eye video source in different files respectively. When playing 3D video, the left-eye video source and right-eye video source are read out separately from two files, thereby the 3D video source is synthesized by left-eye video source and right-eye video source.

However, storing left-eye video source and right-eye video source in different files respectively may lead to failure of synthesis of 3D video in case that either one file is lost in transmission or in a preservation process. Particularly when a player client plays 3D videos online on the internet, data can be read out from files only when both two files have been downloaded so that it is possible to synthesize and further play the 3D video.

During downloading, the 3D video cannot be played, which thereby delays online playing of 3D video.

### SUMMARY

Accordingly, it is necessary to provide a method for storing a 3D video source, which is not only able to store a left-eye video source and a right-eye video source in a same file, but also able to meet the need of downloading while playing.

A method for storing 3D video source includes:

alternately storing video frames of a left-eye video source and a right-eye video source in media data storage units of a multimedia storage file in a chronological order; and

storing media information of the left-eye video source and the right-eye video source respectively in different media information storage units of the multimedia storage file.

Accordingly, it's necessary to provide an apparatus for storing 3D video source, which is not only able to store a left-eye video source and a right-eye video source in a same file, but also able to meet the need of downloading while playing.

An apparatus for storing 3D video source includes:

a media data storing module configured to alternately store video frames of a left-eye video source and a right-eye video source in media data storage units of a multimedia storage file in a chronological order; and

a media information storing module configured to store media information of the left-eye video source and the right-eye video source respectively in different media information storage units of the multimedia storage file.

Besides, a computer storage media is provided. One or more computer storage medium which includes computer instructions configured to execute the method for storing 3D video source. The method includes: alternately storing video frames of a left-eye video source and a right-eye video source in media data storage units of a multimedia storage file in a chronological order; and storing media information of the left-eye video source and the right-eye video source respectively in different media information storage units of the multimedia storage file.

The above method, apparatus for storing 3D video source, storing the left-eye video source and the right-eye video source of a same video in a multimedia storage file instead of two files, a video is corresponded to a storage file. It's convenient to transport and preserve the video files, and avoid failure of synthesis of 3D video in case either one file is lost in transmission or preservation process. In addition, the above method and apparatus for storing 3D video source, alternately storing video frames of a left-eye video source and a right-eye video source in media data storage units of a multimedia storage file in a chronological order. When player clients play 3D videos online, it is able to synthesize 3D video with the left-eye video source and right-eye video source obtained from the downloaded media stream data while downloading continuous media stream data of multimedia storage files simultaneously. It can synthesize 3D video without all the download is complete to meet requirement for playing while downloading. Accordingly, it's necessary to provide a method for playing 3D video source which is able to meet the need of downloading while playing online.

A method for playing 3D video includes: obtaining a multimedia storage file storing left-eye video source and right-eye video source, wherein video frames of the left-eye video source and the right-eye video source are alternately stored in media data storage units of multimedia storage file in a chronological order;

reading media information of the left-eye video source and the right-eye video source respectively from the media information storage units corresponding to the left-eye video source and the right-eye video source;

reading the video frames of the left-eye video source and the right-eye video source that are corresponded to a same time from the media data storage units of the multimedia storage file, according to the media information of the left-eye video source and the right-eye video source;

synthesizing 3D video images by arranging the video frames of the left-eye video source and the right-eye video source that are corresponded to a same time in a preset mode;

playing the synthesis 3D video images. Accordingly, it's necessary to provide an apparatus for playing 3D video source which is able to meet the need of downloading while playing online.

An apparatus for playing 3D video includes:

a file obtaining module configured to obtain a multimedia storage file storing left-eye video source and right-eye video source, wherein video frames of the left-eye video source and the right-eye video source are alternately stored in media data storage units of the multimedia storage file in a chronological order;

a media information reading module configured to read media information of the left-eye video source and the right-eye video source respectively from the media information storage units corresponding to the left-eye video source and the right-eye video source;

a media data reading module configured to read the video frames of the left-eye video source and the right-eye video source that are corresponded to a same time from the media data storage units of the multimedia storage file, according to the media information of the left-eye video source and the right-eye video source;

a synthesizing module configured to synthesizing 3D video images by arranging the video frames of the left-eye video source and the right-eye video source that are corresponded to a same time in a preset mode;

a playing module configured to play the synthesis 3D video images.

Besides, a computer storage media is provided.

One or more computer storage medium which includes computer instructions configured to execute the method for playing 3D video source. The method includes:

obtaining a multimedia storage file storing left-eye video source and right-eye video source, wherein video frames of the left-eye video source and the right-eye video source are alternately stored in media data storage units of multimedia storage file in a chronological order;

reading media information of the left-eye video source and the right-eye video source respectively from the media information storage units corresponding to the left-eye video source and the right-eye video source;

reading the video frames of the left-eye video source and the right-eye video source that are corresponded to a same time from the media data storage units of the multimedia storage file, according to the media information of the left-eye video source and the right-eye video source;

synthesizing 3D video images by arranging the video frames of the left-eye video source and the right-eye video source that are corresponded to a same time in a preset mode; playing the synthesis 3D video images.

The above method, apparatus for playing 3D video source and executable instruction configured to play 3D video source in computer storage media, read video frames of the left-eye and the right-eye video source from media data storage unit of media storage file according to the left-eye and the right-eye video sources' media information, synthesize 3D video images by the left-eye and the right-eye video source's video frame which are corresponded to a same time. It is able to obtain media data of multimedia storage file while synthesizing 3D video images without all the download is complete to meet requirement for playing while downloading.

### BRIEF DESCRIPTION OF THE DRAWINGS

FIG. 1 is a flow chart of a method for storing 3D video according to an embodiment.

FIG. 2 is a block diagram of an apparatus for storing 3D video according to an embodiment.

FIG. 3 is a flow chart of a method for playing 3D video according to an embodiment.

FIG. 4 is a block diagram of an apparatus for playing 3D video according to an embodiment.

### DETAILED DESCRIPTION OF THE EMBODIMENTS

Referring to FIG. 1, in accordance with an embodiment, a method for storing 3D video includes:

Step 101, alternately storing video frames of a left-eye video source and a right-eye video source in media data storage units of a multimedia storage file in a chronological order.

The multimedia storage file can be MP4 file, MP5 file or other files of specific types, etc.

In an embodiment, the multimedia storage file is an MP4 file, and the media data storage unit is a media data box of the MP4 file.

All data of the MP4 file are stored in box (in Quick time, the box is the atom). In other words, the MP4 file is composed by several boxes. Each box has a type and a length, a box can be regarded as a data object block. One box may include another box, in which situation the box is called container box.

An MP4 file only includes one “moov” type box (Movie Box) which is a container box. Sub boxes include relevant information of media data of the MP4 file which would hereinafter be referred to as media information. Track box is a sub box of “moov” type box; each Track box includes media information of a single video stream. Another box of an MP4 file is “mdat” box (Media Data Box). Media Data Box includes media data of multimedia storage file. The structure of the media data is described by the media information that is included in Movie Box.

Specifically, video frames of the left-eye video source and the right-eye video source are arranged in the media data storage units of a multimedia storage file according to chronological order of time.

In an embodiment, the media data storage units of the multimedia storage file stores neighboring video frames of the left-eye video source and the right-eye video source, and time of the video frames are corresponded to a same time. Corresponding to a same time represents that the time of the video frames is the same or similar (interval is less than the preset threshold value).

For example, video frames of the left-eye video source and the right-eye video source could be stored in the media data storage units in the following order: a first frame of the left-eye video source, a first frame of the right-eye video source, a second frame of the left-eye video source, a second frame of the right-eye video source, etc. The left-eye and right-eye video sources are screened simultaneously from different angles, therefore, the numbers of the video frames of respectively the left-eye and right-eye video sources are the same or similar, wherein video frames with the same number would be corresponded to the same time.

In an embodiment, the video frame could be a video frame or a group of consecutive video frames. A unit that is composed with a group of consecutive video frames is called “chunk”. In an embodiment, chunks of the left-eye video source and the right-eye video source could be stored alternately in a chronological order, and the neighboring chunks of left-eye video source and right-eye video source are corresponded to a same time.

For example, chunks of the left-eye video source and the right-eye video source could be stored in the media data storage units in the following order: a chunk of the left-eye video source in 0˜1 second, a chunk of the right-eye video source in 0˜1±k second, a chunk of the left-eye video source in 1˜2 second, a chunk of the right-eye video source in 1±k˜2 35 k second, etc. Wherein, k is a preset threshold.

Step 102, storing the media information of the left-eye video source and the right-eye video source in different media information storage units of the multimedia storage file.

In an embodiment, the media information storage unit is the Track Box of MP4 file.

Specifically, media information includes time information of the video frames, position information, and codec information of the video frames in the video source.

When it is needed to obtain video frames of the left-eye and right-eye video sources, position information of video frames that is corresponding to the relevant time is obtained according to the time and position information of video frame. Further, the video frame data is retrieved from the media data storage unit of the multimedia storage file according to the position information. Besides, the video frame data is decoded in accordance with the codec information.

In this embodiment, video frames of the left-eye video source and the right-eye video source are stored in media data storage units of a multimedia storage file alternately in a chronological order, and corresponding the time of video frames of the left-eye video source to the time of the neighboring video frames of the right-eye video source that are stored in the media data storage unit. As synthesizing 3D video, it is convenient to obtain the video frames, which have been corresponded to a same time, of the left-eye and right-eye video sources from a continuous media stream in the multimedia storage file. Thereby, it is able to download media steam of MP4 while synthesizing 3D video images simultaneously by video frames that are obtained from the downloaded continuous media stream and have been corresponded to a same time, to meet the need of downloading while playing 3D video online.

In an embodiment, before Step 101, the method for storing 3D video source includes: encoding left-eye and right-eye video sources according to a preset mode.

In this embodiment, the specific process of Step 101 is: storing the encoded video frame of left-eye video source and right-eye video source in media data storage units of a multimedia storage file alternately in a chronological order.

Specifically, video of left-eye video source and right-eye video source could be encoded by conventional video encode mode (such as H.264 mode). Moreover, the encoded left-eye video source and right-eye video source are stored.

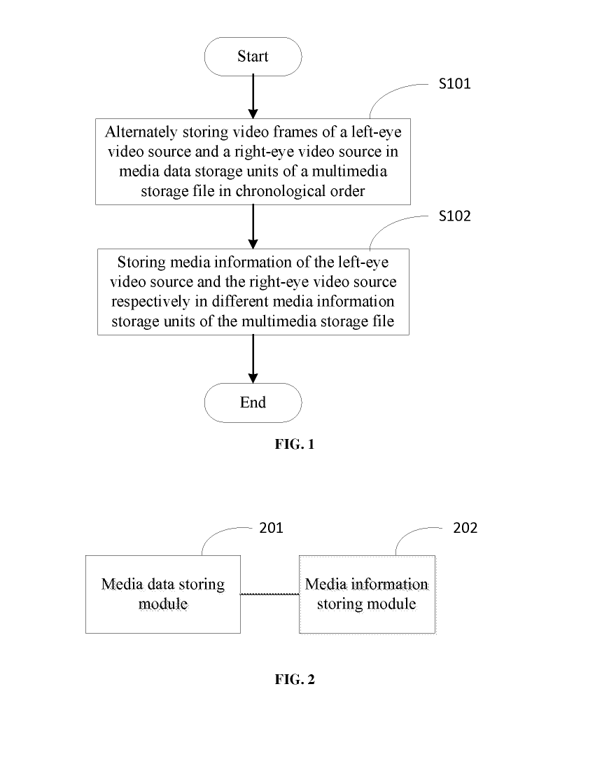

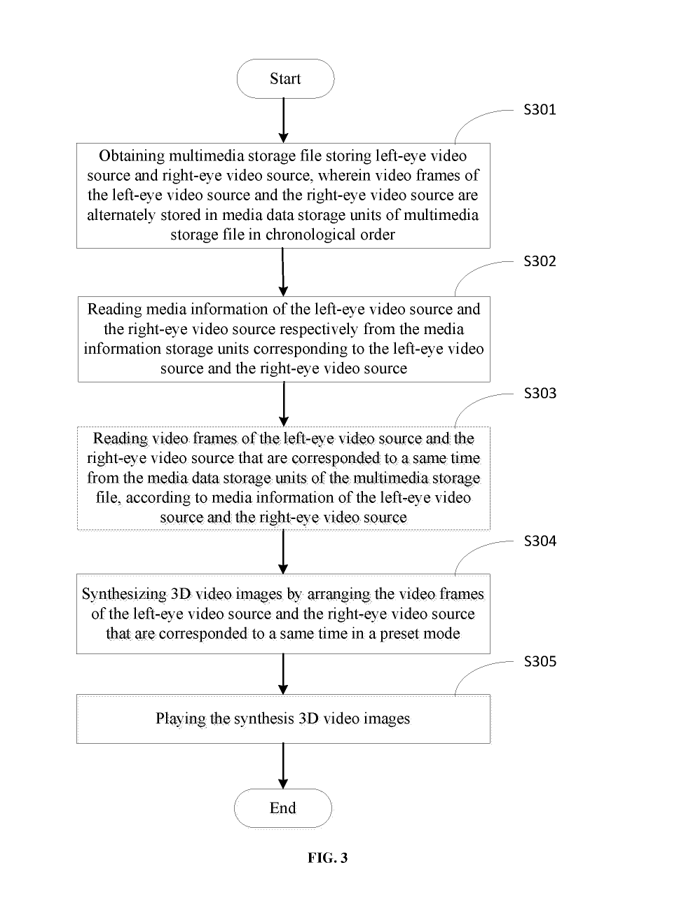

Referring to FIG. 2, in an embodiment, an apparatus for storing 3D video includes a media data storing module 201 and a media information storing module 202, wherein:

The media data storing module 201 is configured to alternately store video frames of a left-eye video source and a right-eye video source in media data storage units of a multimedia storage file in a chronological order. The multimedia storage file can be MP4 file, MP5 file or other files of specific types, etc.

In an embodiment, the multimedia storage file is an MP4 file, and the media data storage unit is a media data box of the MP4 file.

Specifically, video frames of the left-eye video source and the right-eye video source are arranged in the media data storage units of a multimedia storage file according to chronological order of time.

In an embodiment, the media data storage units of the multimedia storage file stores video frames of the left-eye video source and right-eye video source, and time of the neighboring video frames are corresponded to a same time. Corresponding to a same time represents that the time of the video frames is the same or similar (interval is less than the preset threshold value).

For example, the media data storing module 201 is configured to store video frames of the left-eye video source and the right-eye video source in the media data storage units in the following order: a first frame of the left-eye video source, a first frame of the right-eye video source, a second frame of the left-eye video source, a second frame of the right-eye video source, etc. The left-eye and right-eye video sources are screened simultaneously from different angles, therefore, the numbers of the video frames of respectively the left-eye and right-eye video sources are the same or similar, wherein video frames with the same number would be corresponded to the same time.

In an embodiment, the video frame could be a video frame or a group of consecutive video frames. A unit that is composed with a group of consecutive video frames is called “chunk”. In an embodiment, media data storing module 201 is configured to store chunks of the left-eye video source and the right-eye video source alternately in a chronological order, and the neighboring chunks of left-eye video source and right-eye video source are corresponded to a same time.

For example, media data storing module 201 is configured to store chunks of the left-eye video source and the right-eye video source in the media data storage units in the following order: a chunk of the left-eye video source in 0˜1 second, a chunk of the right-eye video source in 0˜1±k second, a chunk of the left-eye video source in 1˜2 second, a chunk of the right-eye video source in 1±k˜2±k second, etc. Wherein, k is a preset threshold.

The media information storing module 202 is configured to store the media information of the left-eye video source and the right-eye video source in different media information storage units of the multimedia storage file.

In an embodiment, the media information storage unit is the Track Box of MP4 file.

Specifically, media information includes time information of the video frames, position information, and codec information of the video frames in the video source.

When it is needed to obtain video frames of the left-eye and right-eye video sources, position information of video frames that is corresponding to the relevant time is obtained according to the time and position information of video frame. Further, the video frame data is retrieved from the media data storage unit of the multimedia storage file according to the position information. Besides, the video frame data is decoded in accordance with the codec information.

In this embodiment, video frames of the left-eye video source and the right-eye video source are stored in media data storage units of multimedia storage file alternately in a chronological order, and corresponding the time of video frames of the left-eye video source to the time of neighboring video frames of the right-eye video source that are stored in the media data storage unit. As synthesizing 3D video, it's convenient to obtain the video frames, which have been corresponded to a same time, of the left-eye and right-eye video sources from continuous media stream in the multimedia storage file. Thereby, it is able to download media steam of MP4 while synthesizing 3D video images simultaneously by video frames that are obtained from the downloaded continuous media stream and have been corresponded to a same time, to meet the need of downloading while playing 3D video online.

In an embodiment, the above apparatus for storing 3D video also includes encoding module (not shown in the figures), configured to encode left-eye and right-eye video sources according to a preset mode.

In this embodiment, media data storing module 201 is configured to store the encoded video frame of left-eye video source and right-eye video source in media data storage units of a multimedia storage file alternately in a chronological order.

Specifically, encoding module is able to video of left-eye video source and right-eye video source by conventional video encode mode (such as H.264 mode). Moreover, media data storing module 201 is able to store the encoded left-eye video source and right-eye video source.

The above method, apparatus for storing 3D video source, storing the left-eye video source and the right-eye video source of a same video in a multimedia storage file instead of two files, a video is corresponded to a storage file. It is convenient to transport and preserve the video files, and avoid failure of synthesis of 3D video in case either one file is lost in transmission or in a preservation process.

In addition, the above method and apparatus for storing 3D video source alternately stores video frames of a left-eye video source and a right-eye video source in media data storage units of a multimedia storage file in a chronological order. When a player client plays 3D videos online, it is able to synthesize 3D video with the left-eye video source and right-eye video source obtained from the downloaded media stream data while downloading continuous media stream data of multimedia storage files simultaneously. It can synthesize 3D video without all the download being complete, to thereby meet the requirement for playing while downloading.

Besides, compared with storing the synthesized 3D video using the left-eye video source and right-eye video source of a fixed format, the above method for storing 3D video source is advantageous to synthesize 3D video later by different format according to user needs. A video file can meet different needs for synthesizing 3D video, without storing multiple video files of different synthesis format. Therefore, the above method saves more storage resources, and saves transmission resources when transportation of video files is required.

Referring to FIG. 3, in an embodiment, a method for playing 3D video includes:

Step 301, obtaining a multimedia storage file storing left-eye video source and right-eye video source, wherein video frames of the left-eye video source and the right-eye video source are alternately stored in media data storage units of the multimedia storage file in a chronological order.

Specifically, the multimedia storage file is obtained according to the specified path, or the multimedia storage file is downloaded according to the internet address.

The multimedia storage file can be MP4 file, MP5 file or other files of specific types, etc.

In an embodiment, the multimedia storage file is MP4 file, and the media data storage unit is media data box of the MP4 file.

Video frames of the left-eye video source and the right-eye video source are respectively arranged in corresponding media data storage units according to chronological order of time.

Neighboring video frame of the left-eye video source and the right-eye video source stored in media data storage units of the multimedia storage file are corresponded to a same time. Video frames corresponding to a same time represents that time of the video frames is the same or similar (interval is less than the preset threshold value).

Step 302, reading media information of the left-eye video source and the right-eye video source respectively from the media information storage units corresponding to the left-eye video source and the right-eye video source. In an embodiment, the media information storage unit is Track Box of MP4 file.

Step 303, reading video frames of the left-eye video source and the right-eye video source that are corresponded to a same time from the media data storage units of the multimedia storage file, according to the media information of the left-eye video source and the right-eye video source.

Specifically, in an embodiment, position information of video frames corresponding to a same time of the left-eye and right-eye video sources are obtained according to the left-eye and right-eye video sources' time and position information. The video frame data corresponding to a same time is read from the media data storage unit of the multimedia storage file according to the position information.

Step 304, synthesizing 3D video images by arranging in a preset mode video frames of the left-eye video source and the right-eye video source which are corresponded to a same time.

Specifically, 3D video images can be synthesized by video frames of the left-eye and right-eye video sources that are corresponded to a same time, according to conventional mode such as left and right arrangement, up and down arrangement, and staggered arrangement, etc. Herein, left and right arrangement mode arranges left-eye video source to the left and right-eye video source to the right; up and down arrangement mode arranges left-eye video source to the top and right-eye video source to the bottom, staggered arrangement mode arranges pixel columns of left-eye and right-eye video source's video frame alternately. As different 3D player devices are adapted to different formats, 3D video could be accordingly synthesized in compliance with 3D player devices.

In this embodiment, video frames of the left-eye video source and the right-eye video source are stored in media data storage units of a multimedia storage file alternately in a chronological order, and corresponding the time of video frames of the left-eye video source to the time of neighboring video frames of the right-eye video source that are stored in the media data storage unit. As synthesizing 3D video, it is convenient to obtain the video frames, which have been corresponded to a same time, of the left-eye and right-eye video sources from continuous media stream in the multimedia storage file. Thereby, it is able to download media steam of MP4 while synthesizing 3D video images simultaneously by video frames that are obtained from the downloaded continuous media stream and have been corresponded to a same time, to meet the need of downloading while playing 3D video online.

Step 305, playing the synthesis 3D video images.

In an embodiment, the left-eye and right-eye video source are encoded by the preset mode. Before Step 304, the method for playing 3D video source includes: decoding the left-eye and right-eye video source data by the preset mode. The specific process of Step 304 is: synthesizing 3D video images by arranging the decoded video frames of the left-eye video source and the right-eye video source which are corresponded to a same time in a preset mode.

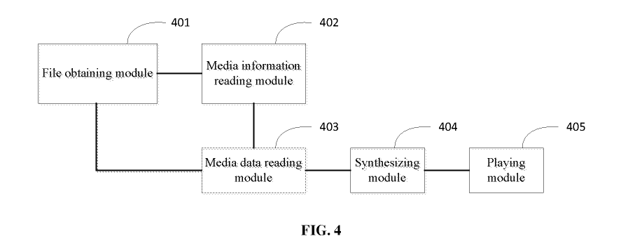

Referring to FIG. 4, in an embodiment, an apparatus for playing 3D video includes a file obtaining module 401, a media information reading module 402, a media data reading module 403, a synthesizing module 404 and a playing module 405, wherein:

The file obtaining module 401 is configured to obtain multimedia storage file storing left-eye video source and right-eye video source, wherein video frames of the left-eye video source and the right-eye video source are alternately stored in media data storage units of a multimedia storage file in a chronological order.

Specifically, the multimedia storage file is obtained according to the specified path, or the multimedia storage file is downloaded according to the internet address.

The multimedia storage file can be MP4 file, MP5 file or other files of specific types, etc.

In an embodiment, the multimedia storage file is MP4 file, and the media data storage unit is media data box of the MP4 file.

Video frames of the left-eye video source and the right-eye video source are respectively arranged in corresponding media data storage units according to chronological order of time.

Neighboring video frame of the left-eye video source and the right-eye video source stored in media data storage units of the multimedia storage file are corresponded to a same time. Video frames corresponding to a same time represents that time of the video frames is the same or similar (interval is less than the preset threshold value).

The media information reading module 402 is configured to read media information of the left-eye video source and the right-eye video source respectively from the media information storage units corresponding to the left-eye video source and the right-eye video source.

In an embodiment, the media information storage unit is Track Box of MP4 file.

The media data reading module 403 is configured to read video frames of the left-eye video source and the right-eye video source that are corresponded to a same time from the media data storage units of the multimedia storage file, according to the media information of the left-eye video source and the right-eye video source.

Specifically, in an embodiment, the media data reading module 403 is configured to obtain position information of video frames corresponding to a same time of the left-eye and right-eye video sources according to the left-eye and right-eye video sources' time and position information. Moreover, the video frame data corresponding to a same time is read from the media data storage unit of the multimedia storage file according to the position information.

The synthesizing module 404 is configured to synthesize 3D video images by arranging in a preset mode video frames of the left-eye video source and the right-eye video source which are corresponded to a same time.

Specifically, the synthesizing module 404 is configured to synthesize 3D video images by video frames of the left-eye and right-eye video sources that are corresponded to a same time according to conventional mode such as left and right arrangement, up and down arrangement, and staggered arrangement, etc. Herein, left and right arrangement mode arranges left-eye video source to the left and right-eye video source to the right; up and down arrangement mode arranges left-eye video source to the top and right-eye video source to the bottom, staggered arrangement mode arranges pixel columns of left-eye and right-eye video source's video frame alternately. As different 3D player devices are adapted to different formats, the synthesizing module 404 is able to accordingly synthesize 3D video in compliance with 3D player devices.

In this embodiment, video frames of the left-eye video source and the right-eye video source are alternately stored in media data storage units of a multimedia storage file in a chronological order, and the neighboring video frames of the left-eye video source and right-eye video source are corresponded to the same time. As synthesizing 3D video, it is convenient to obtain the video frames, which have been corresponded to a same time, of the left-eye and right-eye video sources from continuous media stream in the multimedia storage file. Thereby, it is able to download media steam of MP4 while synthesizing 3D video images simultaneously by video frames that are obtained from the downloaded continuous media stream and have been corresponded to a same time, to meet the need of downloading while playing 3D video online.

The playing module 405 is configured to play the synthesis 3D video images.

In an embodiment, the left-eye and right-eye video source are encoded by the preset mode.

The above apparatus also includes decoding module (not shown in the figures), the decoding module is configured to decode the left-eye and right-eye video source data by the preset mode. The synthesizing module 404 is configured to synthesize 3D video images by arranging the decoded video frames of the left-eye video source and the right-eye video source which are corresponded to a same time in a preset mode.

The above method and apparatus read the left-eye video source and the right-eye video source from a multimedia storage file, and synthesize 3D video images by video frame of the left-eye and the right-eye video source which are corresponding to a same time. The above method and apparatus avoid the conventional manner of reading the left-eye video source and the right-eye video source from two files, respectively. Moreover, the above method and apparatus overcome conventional systems inability to synthesis and play 3D video in the case that one file is lost.

In addition, the above method and apparatus are configured to read video frames of the left-eye and the right-eye video source from media data storage unit of a media storage file according to the left-eye and the right-eye video sources' media information, and to synthesize 3D video images by the left-eye and the right-eye video source's video frame which are corresponded to a same time. The above method and apparatus are able to obtain media data of a multimedia storage file while synthesizing 3D video images, without all the download being complete. Therefore, the above method and apparatus can play while downloading.

Moreover, the above method and apparatus for playing 3D video are advantageous in being able to synthesize 3D video by different format to meet needs of different player devices.

It should be appreciated by those skilled in the art that all or part of the steps of the method described in the embodiments above may be executed by relevant hardware instructed by a program that may be stored in a computer-readable memory medium. The readable memory medium may be, for example, a read-only memory (ROM), a random access memory (RAM), a magnetic disk or a compact disc.

The embodiments described above are merely preferred ones of the present disclosure but are not limitations to the protection scope of the present disclosure, and any variations or substitutions easily devised by those skilled in the art without departing from the spirit of the present disclosure fall within the scope of the protection. Therefore, the protection scope of the present disclosure shall be subject to that specified by the appended claims.

What is claimed is:

1. A method comprising:
alternately storing video frames of a left-eye three-dimensional (3D) video source and a right-eye 3D video source in media data storage units of a multimedia storage file in a chronological order; and
storing media information of the left-eye 3D video source and the right-eye 3D video source respectively in different media information storage units of the multimedia storage file.

2. The method according to claim 1, wherein neighboring video frames of the left-eye 3D video source and the right-eye 3D video source that are stored in the media data storage units of the multimedia storage file are corresponded to a same time;
the media information comprises time information of the video frames, position information, and codec information of the video frames in the left-eye 3D video source and the right-eye 3D video source.

3. The method according to claim 1, wherein the multimedia storage file is an MP4 file, the media data storage units are media data boxes of the MP4 file, the media information storage unit are Track boxes of the MP4 file.

4. An apparatus comprising:
a media data storing module configured to alternately store video frames of a left-eye three-dimensional (3D) video source and a right-eye 3D video source in media data storage units of a multimedia storage file in a chronological order; and
a media information storing module configured to store media information of the left-eye 3D video source and the right-eye 3D video source respectively in different media information storage units of the multimedia storage file.

5. The apparatus according to claim 4, wherein a neighboring video frames of the left-eye 3D video source and the right-eye 3D video source that are stored in media data storage unit of the multimedia storage file are corresponded to a same time;
the media information comprises time information of the video frames, position information, and codec information of the video frames in the left-eye 3D video source and the right-eye 3D video source.

6. The apparatus according to claim 4, wherein the multimedia storage file is an MP4 file, the media data storage units are media data boxes of the MP4 file, the media information storage unit are Track boxes of the MP4 file.

7. A method comprising:
obtaining a multimedia storage file storing a left-eye three-dimensional (3D) video source and a right-eye 3D video source, wherein video frames of the left-eye 3D video source and the right-eye 3D video source are alternately stored in media data storage units of a multimedia storage file in a chronological order;
reading media information of the left-eye 3D video source and the right-eye 3D video source respectively from the media information storage units corresponding to the left-eye video source and the right-eye video source;
reading the video frames of the left-eye 3D video source and the right-eye 3D video source that are corresponded to a same time from the media data storage units of the multimedia storage file, according to the media information of the left-eye 3D video source and the right-eye 3D video source read by said reading media information;
synthesizing, in a preset mode, 3D video images by arranging the video frames of the left-eye 3D video source and the right-eye 3D video source read by said reading video frames; and
playing the synthesis 3D video images.

8. The method according to claim 7, wherein neighboring video frames of the left-eye 3D video source and the right-eye 3D video source that are stored in the media data storage units of the multimedia storage file are corresponded to a same time.

9. The method according to claim 7, wherein the multimedia storage file is an MP4 file and the media data storage unit is a media data box of the MP4 file, the media information storage unit is a Track box of the MP4 file.

10. An apparatus comprising:
a file obtaining module configured to obtain a multimedia storage file storing a left-eye three-dimensional (3D) video source and a right-eye 3D video source, wherein video frames of the left-eye 3D video source and the right-eye 3D video source are alternately stored in media data storage units of the multimedia storage file in a chronological order;
a media information reading module configured to read media information of the left-eye 3D video source and the right-eye 3D video source respectively from the media information storage units corresponding to the left-eye video source and the right-eye video source;
a media data reading module configured to read the video frames of the left-eye 3D video source and the right-eye 3D video source that are corresponded to a same time from the media data storage units of the multimedia storage file, according to the media information of the left-eye 3D video source and the right-eye 3D video source read by the media information reading module;
a synthesizing module configured to synthesizing, in a preset mode, 3D video images by arranging the video frames of the left-eye 3D video source and the right-eye 3D video source read by the media data reading module; and
a playing module configured to play the synthesis 3D video images.

11. The apparatus according to claim 10, wherein neighboring video frames of the left-eye 3D video source and the right-eye 3D video source that are stored in the media data storage units of the multimedia storage file are corresponded to a same time.

12. The apparatus according to claim 10, wherein the multimedia storage file is an MP4 file and the media data storage units are media data boxes of the MP4 file, the media information storage unit is a Track box of the MP4 file.
